(19) United States
(12) Patent Application Publication
(10) Pub. No.: US 2024/0026623 A1
(43) Pub. Date: Jan. 25, 2024

(54) MOORING POLE

(71) Applicant: E-CONCEPT S.R.L., Venezia (IT)

(72) Inventors: Matteo BARTOLI, Venezia (IT); Claudio IANNELLI, Venezia (IT)

(73) Assignee: E-CONCEPT S.R.L., Venezia (IT)

(21) Appl. No.: 18/030,009

(22) PCT Filed: Sep. 30, 2021
(86) PCT No.: PCT/IB2021/058994

§ 371 Date: Apr. 3, 2023

(30) Foreign Application Priority Data
Oct. 6, 2020 (IT) 102020000023521

(51) Int. Cl. E02B 3/24; B60L 53/18; B60L 53/31

(52) U.S. Cl. CPC E02B 3/24; B60L 53/18; B60L 53/31; B60L 2200/32

(57) ABSTRACT

A mooring pole having an appearance similar to that of traditional mooring poles and includes a lower part, configured to be fixed in a seabed, and an upper part configured to remain always above the water level, and to house in its upper part, which is internally hollow, electrical and electronic equipment including at least one electricity meter, powered by an electricity distribution network by means of a submerged cable, to which the pole is connected, a control unit for the electricity supply and at least one electrical socket, to which an external cable can be temporarily inserted for connection to the on-board batteries of a boat moored to said pole.

### FIELD OF THE INVENTION

The present invention relates to a mooring pole.

### BACKGROUND

Mooring poles are known, widespread in all aquatic environments for the constraint and parking of boats in general.

With the progressive diffusion of electric navigation, the possibility of supplying electric power to vessels not only for on-board services but for recharging the batteries used to power the electric motors of the propulsion system of the vessel itself is becoming increasingly important.

Turrets have already been proposed, to which boats can connect to collect electricity for on-board utilities. They are generally designed only to power the auxiliary services of boats and, due to the limited power they are able to deliver and their particular location, almost always limited to piers, ports and marinas, are intended for use by part of a very limited number of subjects and are unable to recharge the batteries on board for the electric propulsion of boats, in contrast with the current trend of favoring the development of this propulsion technique both in work and pleasure boats.

In fact, this trend entails the need to create satisfactory public and private recharging infrastructures, to which users can make adequate use of the needs related to daily private boat transport, both freight and passengers.

### SUMMARY

The present invention proposes to create a capillary recharge network for boats equipped with electric propulsion.

Therefore, the object of the present invention is to propose individual recharging stations, to which boats can access whenever they need to recharge the on-board batteries intended to power the means of electric propulsion as well as the on-board services of the boat itself.

Another object of the invention is to propose single recharging stations which can together constitute a capillary network for the distribution of electrical energy in a nautical environment.

Another object of the invention is to create an electricity distribution network that fits completely into the nautical context without causing any negative environmental impact.

Another object of the invention is to create an electricity distribution network capable of withstanding the multiple stresses associated with the nautical environment without compromising the functionality of the individual stations.

Another object of the invention is to create an electricity distribution network with the possibility of independently accessing the individual stations.

Another object of the invention is to create an electricity distribution network with the possibility of counting and charging the electricity consumed.

All these objects and others that will result from the following description are jointly or separately achieved according to the invention with a mooring pole as defined in the appended claims.

### BRIEF DESCRIPTION OF THE DRAWINGS

The present invention is further clarified hereinafter in some of its preferred embodiments reported at purely illustrative and non-limiting purpose with reference to the attached tables of drawings, in which:

FIG. 1 shows a schematic side view of a mooring pole according to the invention fixed in the seabed next to a quay,

FIG. 2 shows an exploded perspective view of an enlarged detail of the ways of binding the upper part of the pole to the lower part, and

FIG. 3 shows the upper part of the pole deprived of the external covering in a perspective view.

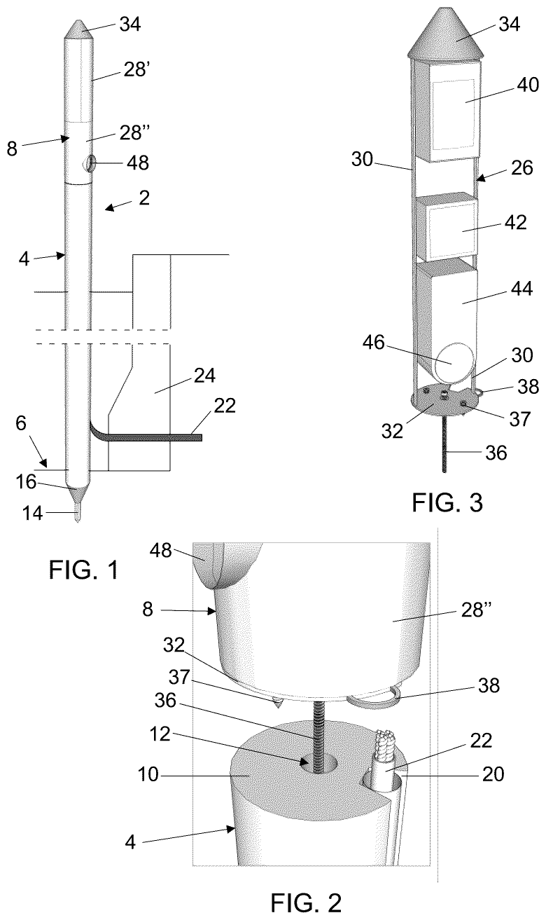

### DETAILED DESCRIPTION OF THE PREFERRED EMBODIMENTS

As can be seen from the figures, the mooring pole 2 according to the invention is outwardly similar to a traditional pole, with an essentially cylindrical body comprising a lower part 4 configured to be suitably fixed in a bottom 6 and an upper part 8 emerging from the bottom of the water.

The lower part 4 of the pole 2 consists of a cylindrical body 10 preferably made of recycled plastic material, of a color suitable for making the pole itself look like wood, similar to traditional mooring poles. The lower part 4 of the pole 2 is internally strengthened by a tubular metal core 12, preferably made of steel and provided below with a driving tip 14, which constitutes the extension of the core 12 and is connected to the cylindrical body by means of a truncated cone portion 16, also preferably of steel.

The upper end of the tubular core 12 is closed by a metal plate (not shown), to which a threaded nut fastening the upper part 8 of the pole is welded in the center, as will be seen better below.

The axial length of the lower part 4 of pole 2 is defined as a function of the depth of the bottom 6, in which the pole 2 must be fixed. In particular, this axial length is chosen as a function of the depth of the seabed, in such a way that even with the maximum predictable tide excursion the top portion of the lower part 4 of pole 2 still protrudes from the water.

For example, if the seabed is 100 cm deep, the maximum predictable tidal excursion is 200 cm and the seabed is such as to require the pole to be driven in for at least 80 cm, the overall length of the lower part 4 of pole 2 must be of at least 380 cm.

The tubular core 12 ends at the top at a slightly lower height than the top of the lower part 4 of the pole 2, so that the upper extremal part of the body 10 of plastic material, having an axial length of about 10 cm, is free from inner core.

Advantageously, the diameter of the tubular core 12 is preferably between 5 and 8 cm and is preferably equal to about 6 cm, while the external diameter of the pole 2, that is, of both its lower part 4 and its upper part 8, is advantageously comprised between 24 and 26 cm and preferably is equal to 25 cm.

However, if the pole should be used for larger boats and/or should be provided for the simultaneous use of several users, and therefore should be equipped with several sockets, its external diameter could reach up to 40 cm.

In any case, the dimensional values now indicated are typical values for mooring poles intended for use in the Venice lagoon, but they could also be different if they refer to poles used in different environmental contexts or also in this context.

At a height of about 70-80 cm from the lower end of the pole 2, and in any case at a height which in conditions of use is immersed in water, an external vertical groove 20 is made in the lower part 4 of the pole 2, designed to accommodate an electrical power supply cable 22, connected to the distribution network and possibly associated with a data cable.

This cable 22, which rests on the bottom or comes from a platform 24, near which the pole 2 is fixed in the bottom 6, then goes up along the lower part 4 of the pole 2 within its external groove 20, and then enters the upper part 8 of the pole itself in correspondence with the joining area between its two parts 4,8. This groove 20 can then advantageously be covered by a suitable section bar or other closing element which has the same color as the plastic material which forms the outer covering 10 of the tubular core 12 of the pole and restores its surface continuity.

The upper part 8 of the pole 2, which extends the lower part 4 of the pole upwards, comprises an internal frame 26 and an external covering formed by two cylindrical shells 28′, 28″ with a diameter substantially equal to the diameter of the lower part 4 of the pole 2, vertically superimposed and removable upwards to access the inside of this, where the frame 26 is located.

This frame 26 preferably comprises a pair of vertical uprights 30, welded at the bottom to a circular plate 32, which constrains the upper part 8 of the pole to its lower part 6, and above an upper conical closure element 34.

Preferably the frame is made of marine grade steel (for example in AISI 316 steel), while the two shells are preferably made of high-strength polymeric material, for example in methacrylate, of a color as similar as possible similar to that of recycled plastic which forms the external coating 10 of the lower part 4 of the pole 2.

The lower plate 32 of the frame 26 presents a central hole for the passage of a screw 36 intended to engage in the nut welded to the underlying closing plate of the tubular core 12 for the constraint of the frame 26 thereto. Furthermore, the plate 32 also presents other holes for the passage of other screws 37 (two in the drawings) intended to engage directly in the plastic material which forms the body of the lower part 4 of the pole. The plate 32 is finally provided with a ring 38 projecting outward and intended for the temporary constraint of the recharging cable of the onboard batteries of the boats.

The top part of the body 10 in recycled plastic of the lower part 4 of the pole is devoid, as mentioned, of an internal tubular core 12, so as to present a limited elastic flexibility, particularly useful for absorbing the vibrations due to the inevitable impacts caused by boats against the pole.

To the frame 26 of the upper part 8 of the pole are applied a series of electrical and electronic equipment necessary for the correct functioning of the pole itself in terms of supplying electricity, managing relations with users and possibly controlling the environment. In particular, these apparatuses comprise at least a watertight box (preferably with IP67 protection degree) for the electricity meter 40, a watertight container 42 for the necessary protections and a control and management unit 44 for user authentication, for supply and monitoring of the electricity supplied and for its accounting.

All these devices are accessible to the staff, thanks to the possibility of at least partial extraction of the two shells 28′, 28″.

Suitable sealing systems, associated with the two shells themselves and not shown in the drawings, ensure sealing against atmospheric agents, which are particularly insidious in a marine environment.

The cable 22, which is housed in the groove 20, enters the upper part 8 of the pole itself in correspondence with the lower plate 32 of the frame 26 and is connected with its conductors to the various apparatuses. It is also envisaged that inside the upper part 8 of the pole 2 and preferably in its top portion, a series of devices for detecting the environmental characteristics and in particular of chemical (CO₂, NOₓ, O₃, SO₂) and physical (PMx and dBA) pollutants.

One or more sockets 46 are also applied to the control unit 44, to which one or more users can connect to draw electrical energy. A single socket 46 will be described hereinafter, but evidently the same description also applies in the case of several sockets, if the same pole 2 must be able to supply several boats at the same time.

Socket 46 is a traditional socket used for charging electric vehicles and is preferably of the type commercially known under the trade name “JuiceBox”. It is accessible from the outside through a circular opening 48 obtained in the lower shell 28″ in correspondence with the socket itself; it can be of the single-phase or three-phase or single-phase and three-phase type, depending on the adopted embodiment.

The supply of electricity can only be activated by a user authorized to access the service and only after having inserted the appropriate Type 2 plug, in accordance with the provisions of the reference standard IEC 61851-1. The standard provides for control electronics that use a “universal” communication system between the control unit 44 and the boat through a PWM (Pulse Width Modulation) circuit, necessary to ensure the safety of the charging process, of people and the boat's battery pack.

All the equipment is housed in containers made of polymeric material suitable for radio frequency transmissions and with an adequate protection class (preferably not less than IP65). Depending on the requirements, a display (not shown) may be applied to the upper part 8 of the pole 2 for the visual control of the various authentication, monitoring and accounting phases of the electrical supply.

Furthermore, it is also envisaged that the pole 2 can be equipped with a video surveillance system in order to be able to monitor the boat while it is parked and recharging the batteries.

For the installation of the pole 2 according to the invention, in the first place, only the lower part 4 is mechanically driven into the selected backdrop 6. This operation is carried out with suitable equipment which takes into account the nature of the seabed and which in any case operates on a lower part 4 of height linked to the depth of the seabed itself. For this reason, it is preferable to have several types of lower parts 4, different from each other in height, so that the installer can choose the most suitable one among them that takes into account the depth of the seabed and that ensures a depth of insertion sufficient to guarantee the pole stability in the most predictable atmospheric, environmental and use conditions. At the same time, the height of the lower part 4 of the pole is chosen according to the maximum predictable excursion of the tide, so as to ensure that its upper part 8 and its junction area with the lower part can never be reached by the water.

After the insertion of the lower part 4 of the pole into the bottom 6, the cable 22 is inserted into the groove 20 of the lower part itself. proximity of the place provided for the insertion of the pole itself.

After the end portion of the cable 22 has been inserted in the groove the groove itself is covered and the cable 22 is made to enter the upper part 8 of the pole, which is then stably bound to the lower part 4 by means of the connection screws 36 and 37.

Subsequently, the various electrical and electronic equipment are mounted on the frame 26 and are then suitably connected to each other and to the conductors of the cable 22.

At the end of this installation phase, the pole 2 is ready to operate. For purely illustrative purposes, the technical specifications of a possible embodiment of the pole 2 are given below.
Diameter of the lower part 4 and of the upper part 8 of the pole: 250-400 mm;
Height of the lower part 4 of the pole variable according to the nature of the depth of the seabed 6 and the maximum predictable excursion of the tide;
Height of the upper part 8 of the pole: max 150 mm;
Mass of the upper part of the pole: about 25 kg;
IP protection degree: meter box: 40 IP67, control unit 44: IP65, charging socket: 46 IP55.
Power output: up to 43 kW depending on the configuration;
TT, TN-C, TN-S earthing system depending on the type of upstream network,
Power supply AC 230 W 1P+N+T (single-phase) and/or AC 400 W 3P+N+E (three-phase);
Materials: AISI 316 steel, methacrylate, MSW recycled plastic;
Operating temperature: −30° C.: +60° C.;
Relative humidity rate supported: 5%: 95%;
Frequency: 50/60 Hz.

For use, when the batteries on board a boat need to be recharged, the user moor the boat to pole 2 with the appropriate lines and then, using a special cable, first plugs it into the socket on board the and then, after having secured it to the appropriate safety ring 38 of the pole 2, it goes down to the ground and only at that moment does it fit the plug into the supply socket 46, which is placed on the pole 2 and which is turned towards the ground. Subsequently, with a dedicated application, he logs into the system with his device and thus enables the opening of the access door to the electrical socket 46, to which he then connects the on-board cable for recharging.

Also via device, it then controls the supply of electricity.

After a predetermined time required for partial or total recharging of the on-board battery, the operator checks from the display, if provided on the pole, or via the application in his mobile device, the quantity of electricity withdrawn and the relative charge.

From what has been said it is clear that the pole according to the invention is particularly advantageous and finds a specific use in the context of the Venice lagoon, where the main means of displacement are made up of boats and the possibility of replacing traditional endothermic engines with electric motors involves a drastic reduction of an important source of environmental pollution.

Another important advantage of the pole according to the invention is the possibility of giving a strong impulse to the electrification of the nautical sector, thanks to the creation of a network for recharging the batteries on board the boats, which on the one hand can be extremely widespread and of on the other hand, it has no environmental impact.

Furthermore, the choice of the particular materials used, namely steel and recycled plastic, allow to combine the duration of the pole over time with the very limited maintenance required.

Another important advantage consists in the possibility of remotely controlling the individual poles, both to verify their correct functioning in conditions of inactivity and during recharging operations, and to promptly detect any anomaly that may arise or should be reported.

Finally, in the desirable spread of electric navigation on the one hand and the recharging network of on-board batteries on the other, the conditions are created to complete the architecture of smart cities with the application of V2G (Vehicle to Grid) technology to the nautical world, with the possibility of operating boats from “deposits” of energy peaks, which the renewable sources of distributed, intermittent, non-programmable and random energy feed into the network.

The present invention has been illustrated and described in some of its preferred embodiments, but it is understood that executive variations may apply thereto in practice, without however departing from the scope of protection of the present patent for industrial invention.

1. Mooring pole having an appearance similar to that of traditional mooring poles and comprises a lower part (4), configured to be fixed in a seabed (6), and an upper part (8) configured to remain always above water level, and to house in its upper part (8), which is internally hollow, electrical and electronic equipment including at least one electricity meter (40), powered by an electricity distribution network by means of a submerged cable (22), to which the pole (2) is connected, a control unit (44) for the electricity supply and at least one electrical socket (46), to which an external cable can be temporarily inserted for connection to on-board batteries of a boat moored to said pole (2).

2. The mooring pole according to claim 1, wherein the lower part (4) includes an internally hollow tubular metal core (12) and an external coating (10) in a plastic material.

3. The mooring pole according to claim 1 further comprising a substantially elastic joint (38) interposed between the lower part (4) and the upper part (8).

4. The mooring pole according to claim 3, wherein said substantially elastic joint is constituted by the upper external coating (10) of said lower part (4) without a tubular metal core (12).

5. The mooring pole according to claim 2, wherein in the external coating (10) of the lower part (4) a longitudinal groove (20) for housing a cable (22) for the electric power supply of the pole is formed.

6. The mooring pole according to claim 1, wherein the upper part (8) comprises an internal frame (26) for supporting said electrical and electronic equipment (40,42,44) and at least one external cylindrical covering (28′, 28″), which upwardly extends the lower part (4) of the pole.

7. The mooring pole according to claim 6 wherein said frame (26) comprises a circular plate (32) for fastening the upper part (8) to the lower part (4) of the pole itself.

8. The mooring pole according to claim 7, wherein the tubular metal core (12) of the lower part (4) is closed at the top by a metal plate bearing at least one nut welded to it, in which a corresponding screw (36) passing through the plate (32) of the frame (26) of said upper part (8) is engaged to constrain said lower part (4) and said upper part (8) to each other.

9. The mooring pole according to claim 6, its wherein the upper part (8) has an external covering consisting of a shell (28′, 28″), which can be removed axially with respect to said frame (26), the shell (28′, 28″) being made of methacrylate.

10. The mooring pole according to claim 9 wherein said electrical socket (46) is mounted on one of said electrical or electronic equipment fixed to said frame (26) and is accessible from the outside through an opening (48) obtained in said external covering (28′, 28″) in a position facing said socket.

11. The mooring pole according to claim 1, further comprising means for its activation in safe conditions by a user.

12. The mooring pole according to claim 1, wherein said electrical socket (46) is associated with means for its activation after a plug of a cable for connection with said on-board batteries has been inserted into said socket (46) from a user ashore.

13. The mooring pole according to claim 1, wherein the upper part (8) houses therein data transmission equipment for remote control of the functionality of the pole.

14. The mooring pole according to claim 1, further comprising equipment for the detection of environmental conditions, housed in the upper part (8).

15. The mooring pole according to a claim 1, further comprising video surveillance equipment, housed in the upper part.
